(19) United States
(12) Patent Application Publication
(10) Pub. No.: US 2009/0269720 A1
(43) Pub. Date: Oct. 29, 2009

(54) Whitening Mouth Piece Device

(76) Inventor: Richard O'Donnell, Spring, TX (US)

Correspondence Address: Richard O'Donnell, 19334 Brittany Creek Dr., Spring, TX, 77388, US

(21) Appl. No.: 12/109,312

(22) Filed: Apr. 24, 2008

(51) Int. Cl. A61C 17/00

(52) U.S. Cl. 433/216

(57) ABSTRACT

A silicone mouthpiece insert for allowing a wearer to whiten their teeth while under a whitening lamp and can be used to hold whitening trays and allow light curing of whitening chemicals for the teeth. The device can also hold whitening sponges, whitening strips and chemicals directly placed in the holder or be used as a one piece whitening tray for both upper and lower teeth all at once allowing for molding of those tray all at once. It also holds open the upper and lower lip to keep the teeth exposed to the lights shining into the center and sides of the mouth to reach the upper and lower, right and left sides of the surface of the teeth.

This application emanates from a previous filing; Provisional application No. 60/923584

### FIELD OF THE INVENTION

This invention relates generally to patient dentition stain removal, and particularly concerns methods, materials, and apparatus which may be advantageously utilized in connection with the whitening or bleaching of a patient's teeth in a dental office.

### BACKGROUND OF THE INVENTION

Present conventional dental practice in the United States for effectively changing the inherent color of patient's teeth basically involves: (1) an in-office teeth whitening procedure that generally requires about one-hour of office time, or (2) in-office preparation of a patient kit with instructions, followed by patient use of the kit in teeth whitening treatments at home of from 1 to 8 hours per day repeated for 2 to 6 weeks.

The in-office teeth whitening procedure usually involves, with a protective rubber dam in place in the patient's mouth: (1) protectively coating the patient's gingival tissues; (2) applying to and activating on the teeth to be whitened a hydrogen peroxide or carbamide peroxide gel; and (3) afterwards completing a thorough mouth rinse and removal of the protective coating and rubber dam.

The dentist-prepared kit for patient home-use typically includes a custom-configured patient bleaching tray or mouth-guard formed by a multi-step in-office procedure, a supply of whitening agent such as carbamide peroxide gel, and appropriate instructions for kit home-use by the patient. The typical multi-step dental office procedure utilized for forming the custom patient tooth-whitening mouth-guard or tray for home use is a time-consuming procedure, and typically involves the basic steps of: (1) making conventional alginate impressions of the patient's maxillary and/or mandibular teeth, (2) casting dentition models using state-of-the-art dental laboratory stone casting material and the alginate impressions, followed by trimming-away of un-needed model material, (3) blocking out on the trimmed cast stone models, using a conventional light-cured or light-activated, acrylic-based resin laboratory block-out gel, those tooth areas to be whitened (often excluding all molar teeth), and (4) vacuum forming a 5-inch by 5-inch sheet of 0.040-inch to 0.080-inch thickness clear plastic resin mouth guard material over each blocked-out and trimmed dental stone model, cooling, removing from model, and suitably trimming above the gingival crest. The whitening mouth guard is then ready for delivery to the patient in the patient home-use whitening kit. As indicated above, home-use of the kit mouth guard and kit-included whitening agent (e.g., carbamide peroxide gel) typically requires 1 to 8-hour bleaching treatments repeated daily over a period that generally is in the range of 2 to 6 weeks depending upon the degree or severity of dentition staining.

I have discovered a novel in-office dental device and procedure that, when utilized in conjunction with most whitening trays and light devices, is an enhancement of the whitening procedure with less components as mine replaces and improves existing technology.

### SUMMARY OF THE INVENTION

The objective of the invention is to hold both bottom and upper Whitening Trays, Sponge applications for whitening teeth, holding open and spreading apart the lips lower and upper during whitening with a teeth whiting lamps or sun lamp whitening devices. It allows for a one piece whitening tray upper and lower, along with a whiting light receptor all in one.

The invention is comprised of one piece, but in its use accepts additional components to add to its use. Shape is oval conforming to the human mouth. It has an upper and lower lip protruding from the front of the piece to hold open the lips and allow the upper and lower lips to rest on the surface of the protruding lip. It has curved inner chamber both upper and lower to accept whitening trays, sponges and their whitening chemicals. The teeth are placed in the inner areas up against the trays or sponges both covering the upper and lower teeth. Whitening trays or sponges are glued or fastened to the whitening light tray dispenser. When constructed as a dual whitening tray it is one component that's material allows for the molding of teeth in both the upper and lower chambers of the unit.

The whole unit is made of Silicon Rubber and can be made of other plastics, thermo plastics and polymers.

The device can be used to hold whitening trays and allow light curing of whitening chemicals for the teeth. It can also hold whitening sponges, whitening strips and chemicals directly placed in the holder. It can also be used as a one piece whitening tray for both upper and lower teeth all at once allowing for molding of those tray all at once. It also holds open the upper and lower lip to keep the teeth exposed to the lights shining into the center and sides of the mouth to reach the upper and lower, right and left sides of the surface of the teeth.

### BRIEF DESCRIPTION OF THE DRAWINGS

FIG. 1 is a perspective view of the front, back, top, bottom and sides identified as;

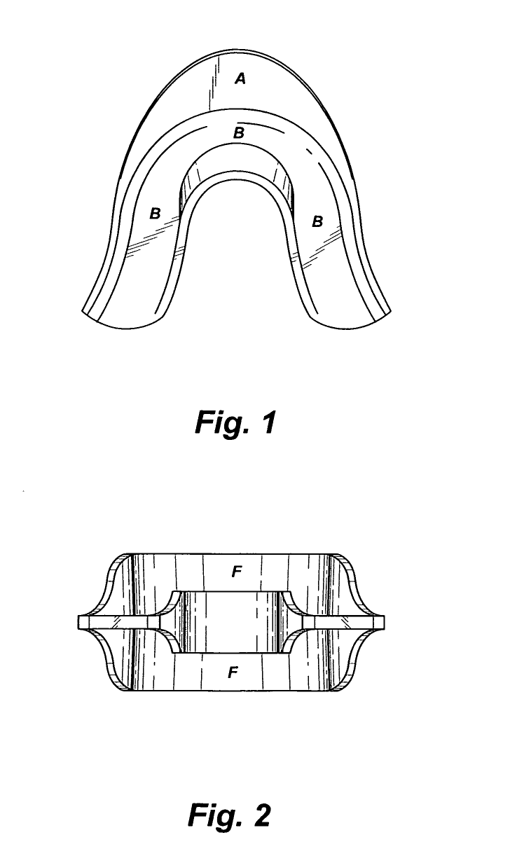

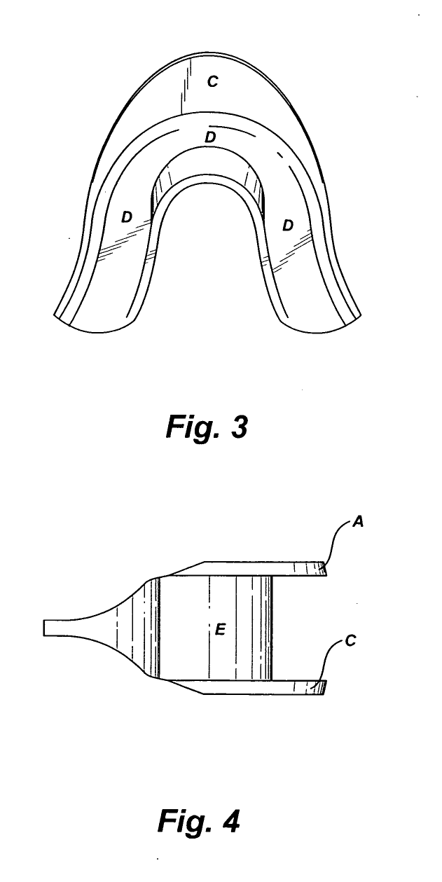

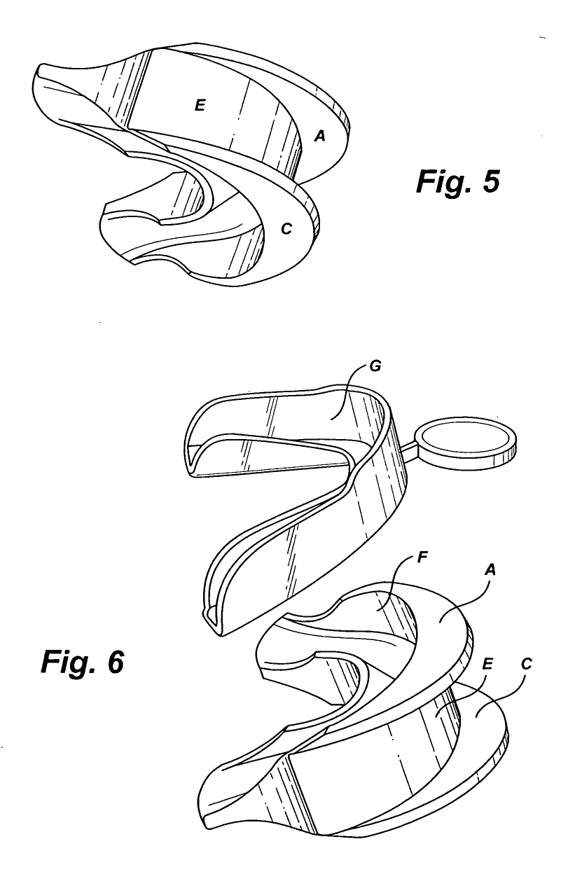

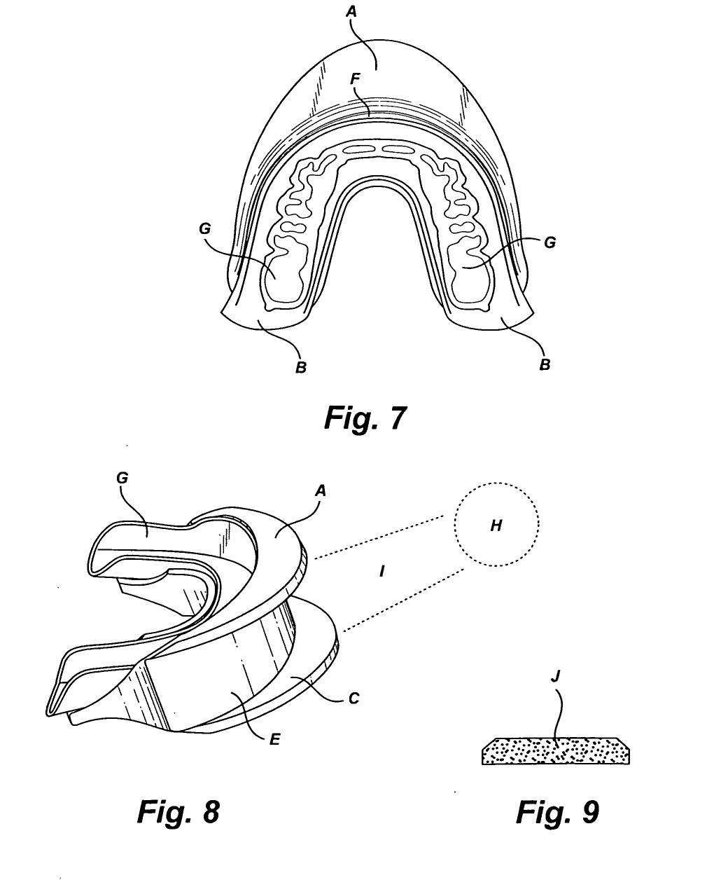

A: Top lip shelf, used to rest the top lip on, so that the lip separates from the bottom lip and is held apart exposing the upper and lower front and side teeth.

B: This area is placed inside the mouth, were both the upper whitening tray and upper teeth are positioned inside the mouth piece. Upper teeth can rest in this area independent of a whitening tray.

C: Lower lip shelf, used to rest the bottom lip on, so that the lip separates from the top lip and is held apart exposing the upper and lower front and side teeth.

D: This area is placed inside the mouth, were both the lower whitening tray and lower teeth are positioned inside the mouth piece. Lower teeth can rest in this area independent of a whitening tray.

E: Front face wall of the mouth piece that allows curing light into the mouth separated by the upper and lower lip shelf exposing the front of the top and bottom teeth exposing the front of the teeth both upper and lower to the curing light.

F: Back face wall of the mouth piece that the upper and lower teeth and/or whitening tray abut up to on the interior of the mouth piece. This upper and lower interior wall can also allows for a sponge to be placed between the wall and the front and lower teeth, the teeth then press up against the sponge and the front wall pressing on the front of the upper and lower teeth. The sponges can be glued to the face of this interior wall stopping the sponges upper and lower from moving within the interior of the mouth piece.

FIG. 2 is a perspective view of the top, front and right sides comprising;

G: Teeth whiting tray placed into area B

H: Light source

I: Light from light source shining in on area E front face wall.

### DESCRIPTION OF THE PREFERRED EMBODIMENT

My device uses two lip shelves (A) and (C) to rest the top lip and the bottom lip holding open the top lip and the bottom lips. The top lip (A) allows the top lip to be held open and rest on this lip shelve protruding from the main mouth piece The bottom lip (C) allows the lower lip to be held open and rest on this lip shelve protruding from the main mouth piece. The teeth chamber of the device (B) is placed in the mouth and is the top place holder for both the upper whitening tray (G) and the upper teeth. The lower chamber (D) simultaneously is placed in the mouth as the lower teeth chamber of the mouth piece place holder for both the lower whitening tray and the lower teeth chamber. A sponge (J) can be placed or glued to the front face inner chamber wall (F) for both the upper and lower front and side teeth. The front face wall (E) allows for the separation of the upper and lower lip shelves (A) and (C). The front face wall (E) allows for the front surface of the teeth both upper and lower to be exposed at the same time from light source (I) shining in on area (E) front face wall light source (H). The upper and lower lips are separated by the front face wall (E) supporting the upper lip shelf (A) protruding from the front face wall (E) of the device. The lower lip shelf (C) is supported by the front face wall (E) supporting the lower lip shelf (C) protruding from the front face wall (E) of the device.

What is claimed is:

1. A whitening light tray dispenser allows for whitening trays inside of the mold to support in the whitening process spreading the lips apart to allow curing lights to pass to the front and sides of the teeth.

2. A whitening light tray dispenser also allows for sponge and chemical application if additional trays are not used. When placed in the mouth, the device will hold open the top and bottom lip allowing curing lights to enter through the front and cure whitening chemicals peroxides in the interior. When using additional trays the trays can be free floating or attached to the whitening dispenser main piece by one of the following ways, glues, plastic snaps, buttons, staples, rivets, screws and nails. The sponge can be free floating, attached by glue, adhesives, adhesive strips. The Whitening light tray Dispenser can be one piece to accept sponges and/or whitening trays or it can be molded/manufactured as one piece with different materials to form the dispenser and the whitening trays as all in one multi whitening tray upper and lower teeth, along with lip holders as a light receptor for curing lights.

3. A whitening mouth piece device to be placed behind the lips and above the gums disposed alongside the buccal and facial surface of a living human maxilla or a human mandible no further than the most posterior tooth of one side to the most posterior tooth of the opposite side of said maxilla or mandible of the opposing side and comprising:
a top lip shelve and a bottom lip shelve exposing the front of the upper and lower teeth;
whereby a front face wall which allows the curing light into the mouth;
said front face wall is apposed by a back face wall of the mouth piece that the upper and lower teeth and/or whitening tray abut up to on the interior of the mouth piece.

4. The whitening mouth piece device as set forth in claim 3, wherein said mouth piece device is constructed of materials to remain soft, maintain shape and memory whereby allowing light to pass through.

5. The whitening mouth piece device as set forth in claim 3, wherein said lip shelves protrude from the single mouth piece allowing for the lips to be spread apart in one mouth piece exposing the teeth to a curing light.

6. The whitening mouth piece device as set forth in claim 3, wherein said device is a one piece mouth piece for both upper and lower teeth whitening with protruding lip shelves.

7. The whitening mouth piece device as set forth in claim 3, wherein said device provides the ability to hold upper and lower whitening single trays while holding open the mouth by separating the lips, allowing the lips to rest on top of the lip shelves comfortable while whitening with an external lighting source.

8. The whitening mouth piece device as set forth in claim 3, wherein said mouth piece provides a single front panel to expose teeth to a light source while holding open the lips that rest on the protruding lip shelf.
